(19) United States
(12) Patent Application Publication
(10) Pub. No.: US 2021/0331365 A1
(43) Pub. Date: Oct. 28, 2021

(54) PLASTICIZING DEVICE, THREE-DIMENSIONAL SHAPING APPARATUS, AND INJECTION MOLDING APPARATUS

(71) Applicant: SEIKO EPSON CORPORATION, Tokyo (JP)

(72) Inventors: Megumi ENARI, SHIOJIRI-SHI (JP); Kenta ANEGAWA, MATSUMOTO-SHI (JP); Riona HAYASHI, SHIOJIRI-SHI (JP)

(21) Appl. No.: 17/239,935

(22) Filed: Apr. 26, 2021

(30) Foreign Application Priority Data
Apr. 28, 2020 (JP) 2020-079297

(51) Int. Cl. B29C 45/60; B29C 45/62; B29C 45/74; B29C 45/47; B29C 64/106; B29C 64/209; B29C 64/314; B33Y 30/00; B33Y 40/10

(52) U.S. Cl. CPC B29C 45/60; B29C 45/62; B29C 45/74; B29C 45/47; B33Y 40/10; B29C 64/209; B29C 64/314; B33Y 30/00; B29C 64/106

(57) ABSTRACT

A plasticizing device includes a screw that has a grooved face provided with a first groove, a barrel that has an opposed face and a communication hole communicating with the first groove at the opposed face, and a heating section that heats a material supplied to the first groove, wherein the first groove includes a central portion opposed to the communication hole, a material supply portion that is provided at an outer circumference of the grooved face , and a coupling portion that couples the central portion to the material supply portion, a second groove that is coupled to the communication hole is provided and when viewed from the rotational axis direction, an end at the outer circumferential side of the second groove is located inside a track drawn by a boundary line between the material supply portion and the coupling portion when the screw is rotated once.

The present application is based on, and claims priority from JP Application Serial Number 2020-079297, filed on Apr. 28, 2020, the disclosure of which is hereby incorporated by reference herein in its entirety.

### BACKGROUND

### 1. Technical Field

The present disclosure relates to a plasticizing device, a three-dimensional shaping apparatus, and an injection molding apparatus.

### 2. Related Art

There has been known a plasticizing device that plasticizes a material.

For example, JP-A-2010-241016 (Patent Document 1) describes a plasticizing and sending-out device including a barrel in which a material inflow path is open to one end face, a rotor having an end face that is slidably in contact with one end face of the barrel, and a spiral groove formed at an end face of the rotor. In the spiral groove, a material is supplied from a radially outer end portion, and also a radially inner end portion communicates with an opening end of the material inflow path of the barrel.

In the plasticizing and sending-out device including the rotor as described above, a material can be stably plasticized by the balance between conveyance of the material and melting of the material. Ideally, it is desirable that in a material supply portion that is the radially outer end portion of the spiral groove, the material is in a solid state, and as the material approaches the radially inner end portion of the spiral groove, the material is transformed into a molten state. For example, when the material is in a molten state in the supply portion, a frictional force of the material against the barrel becomes smaller than a frictional force of the material against the rotor. Therefore, the material is rotated together with the rotor in a skidding manner, and the material cannot be stably plasticized in some cases.

### SUMMARY

One aspect of a plasticizing device according to the present disclosure is directed to a plasticizing device that plasticizes a material, and includes

a screw that is rotated around a rotational axis and that has a grooved face provided with a first groove,
a barrel that has an opposed face opposed to the grooved face and that is provided with a communication hole communicating with the first groove at the opposed face, and
a heating section that heats the material supplied to the first groove, wherein
the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

One aspect of a three-dimensional shaping apparatus according to the present disclosure is directed to a three-dimensional shaping apparatus that shapes a three-dimensional shaped article, and includes

a plasticizing section that plasticizes a material to form a molten material, and
a nozzle that ejects the molten material supplied from the plasticizing section to a stage, wherein
the plasticizing section includes

a screw that is rotated around a rotational axis and that has a grooved face provided with a first groove,

a barrel that has an opposed face opposed to the grooved face and that is provided with a communication hole communicating with the first groove at the opposed face, and

a heating section that heats the material supplied to the first groove,

the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

One aspect of an injection molding apparatus according to the present disclosure includes

a plasticizing section that plasticizes a material to form a molten material, and
a nozzle that injects the molten material supplied from the plasticizing section to a mold, wherein
the plasticizing section includes

a screw that is rotated around a rotational axis and that has a grooved face provided with a first groove,

a barrel that has an opposed face opposed to the grooved face and that is provided with a communication hole communicating with the first groove at the opposed face, and

a heating section that heats the material supplied to the first groove,

the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

### BRIEF DESCRIPTION OF THE DRAWINGS

FIG. 1 is a cross-sectional view schematically showing a three-dimensional shaping apparatus according to the present embodiment.

FIG. 2 is a perspective view schematically showing a flat screw of the three-dimensional shaping apparatus according to the present embodiment.

FIG. 3 is a plan view schematically showing a relative positional relationship between the flat screw and a barrel of the three-dimensional shaping apparatus according to the present embodiment and is a perspective view seen from the bottom of the barrel.

FIG. 4 is a plan view schematically showing the barrel of the three-dimensional shaping apparatus according to the present embodiment.

FIG. 5 is a plan view schematically showing a relative positional relationship between the flat screw and the barrel of the three-dimensional shaping apparatus according to the present embodiment and is a perspective view seen from the bottom of the barrel.

FIG. 6 is a cross-sectional view schematically showing the three-dimensional shaping apparatus according to the present embodiment.

FIG. 7 is a flowchart for illustrating a shaping process of the three-dimensional shaping apparatus according to the present embodiment.

FIG. 8 is a cross-sectional view schematically showing a three-dimensional shaped article shaped by the three-dimensional shaping apparatus according to the present embodiment.

FIG. 9 is a cross-sectional view schematically showing an example in which a second groove overlaps with a material supply portion of a first groove.

FIG. 10 is a cross-sectional view schematically showing the three-dimensional shaping apparatus according to the present embodiment.

FIG. 11 is a plan view schematically showing a relative positional relationship between a flat screw and a barrel of a three-dimensional shaping apparatus according to a first modification of the present embodiment and is a perspective view seen from the bottom of the barrel.

FIG. 12 is a plan view schematically showing the barrel of the three-dimensional shaping apparatus according to the first modification of the present embodiment.

FIG. 13 is a plan view schematically showing a flat screw of a three-dimensional shaping apparatus according to a second modification of the present embodiment.

FIG. 14 is a cross-sectional view schematically showing an injection molding apparatus according to the present embodiment.

### DESCRIPTION OF EXEMPLARY EMBODIMENTS

Hereinafter, preferred embodiments of the present disclosure will be described in detail using the drawings. Note that the embodiments described below are not intended to unduly limit the contents of the present disclosure described in the appended claims. Further, all the configurations described below are not necessarily essential configuration requirements of the present disclosure.

### 1. Three-Dimensional Shaping Apparatus

### 1.1. Configuration

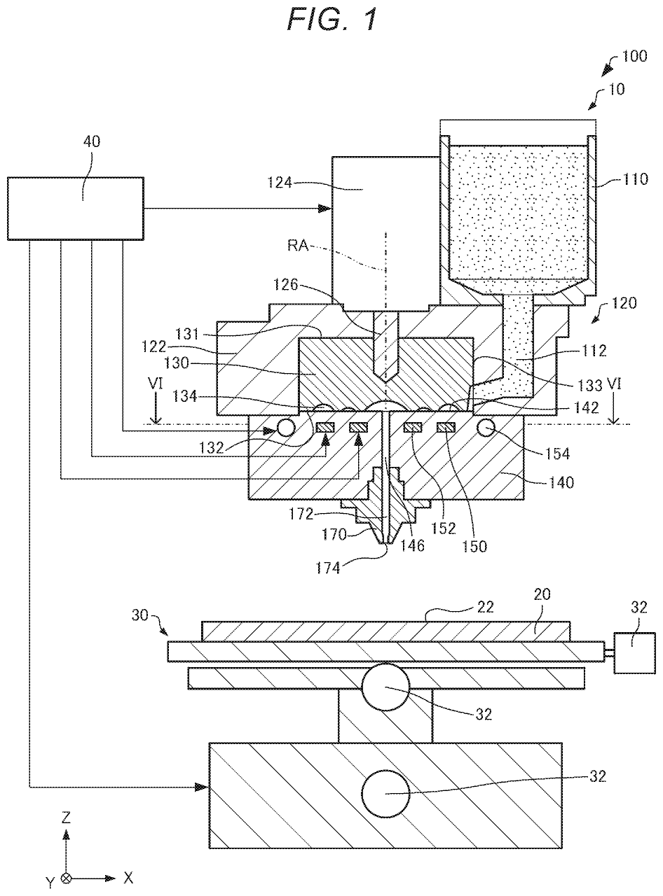

First, a three-dimensional shaping apparatus according to the present embodiment will be described with reference to the drawings. FIG. 1 is a cross-sectional view schematically showing a three-dimensional shaping apparatus 100 according to the present embodiment. Note that in FIG. 1, as three axes orthogonal to one another, X axis, Y axis, and Z axis are shown. An X-axis direction and a Y-axis direction are each, for example, a horizontal direction. A Z-axis direction is, for example, a vertical direction.

The three-dimensional shaping apparatus 100 includes, for example, a shaping unit 10, a stage 20, a moving mechanism 30, and a control unit 40 as shown in FIG. 1.

The three-dimensional shaping apparatus 100 drives the moving mechanism 30 so as to change the relative position of a nozzle 170 of the shaping unit 10 and the stage 20 while ejecting a molten material to the stage 20 from the nozzle 170. By doing this, the three-dimensional shaping apparatus 100 shapes a three-dimensional shaped article having a desired shape on the stage 20. The detailed configuration of the shaping unit 10 will be described below.

The stage 20 is moved by the moving mechanism 30. The three-dimensional shaped article is formed at a shaping face 22 of the stage 20.

The moving mechanism 30 changes the relative position of the shaping unit 10 and the stage 20. In the illustrated example, the moving mechanism 30 moves the stage 20 with respect to the shaping unit 10. The moving mechanism 30 is constituted by a three-axis positioner for moving the stage 20 in the X-axis direction, Y-axis direction, and Z-axis direction by the driving forces of three motors 32. The motors 32 are controlled by the control unit 40.

The moving mechanism 30 may be configured to move the shaping unit 10 without moving the stage 20. Alternatively, the moving mechanism 30 may be configured to move both the shaping unit 10 and the stage 20.

The control unit 40 is constituted by, for example, a computer including a processor, a main storage device, and an input/output interface for performing signal input/output to/from the outside. The control unit 40, for example, exhibits various functions by execution of a program read on the main storage device by the processor. The control unit 40 controls a drive motor 124, heating sections 150 and 152, and a cooling section 154, each of which will be described later, and the moving mechanism 30. The control unit 40 may be constituted by a combination of a plurality of circuits not by a computer.

### 1.2. Shaping Unit

The shaping unit 10 includes, for example, a material feeding section 110, a plasticizing section (plasticizing device) 120, and the nozzle 170 as shown in FIG. 1.

To the material feeding section 110, a material in a pellet form or a powder form is fed. As the material in a pellet form, for example, ABS (acrylonitrile butadiene styrene) is exemplified. The material feeding section 110 is constituted by, for example, a hopper. The material feeding section 110 and the plasticizing section 120 are coupled through a supply channel 112 provided below the material feeding section 110. The material fed to the material feeding section 110 is supplied to the plasticizing section 120 through the supply channel 112.

The plasticizing section 120 includes, for example, a screw case 122, a drive motor 124, a flat screw 130, a barrel 140, a first heating section 150, a second heating section 152, and a cooling section 154. The plasticizing section 120 plasticizes a material in a solid state supplied from the material feeding section 110 so as to form a molten material in a paste form having fluidity, and supplies the molten material to the nozzle 170.

Note that the “plasticization” is a concept including melting, and when a material shows a glass transition temperature, the “plasticization” is to raise the temperature of the material to a temperature equal to or higher than the glass transition temperature, and when a material does not show a glass transition temperature, the “plasticization” is to raise the temperature of the material to a temperature equal to or higher than the melting point, and transformation into a state having fluidity from a solid is referred to as melting or plasticization.

The screw case 122 is a housing that houses the flat screw 130. To a lower face of the screw case 122, the barrel 140 is fixed, and the flat screw 130 is housed in a space surrounded by the screw case 122 and the barrel 140.

The drive motor 124 is fixed to an upper face of the screw case 122. A shaft 126 of the drive motor 124 is coupled to an upper face 131 side of the flat screw 130. The drive motor 124 is controlled by the control unit 40.

The flat screw 130 has a substantially columnar shape in which a size in a direction of a rotational axis RA is smaller than a size in a direction orthogonal to the direction of the rotational axis RA. In the illustrated example, the rotational axis RA is parallel to the Z axis. The flat screw 130 is rotated around the rotational axis RA by a torque generated by the drive motor 124.

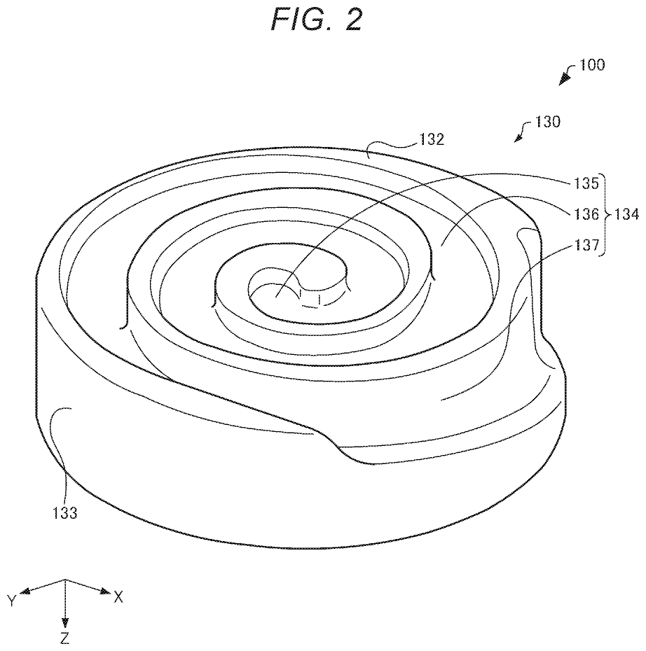

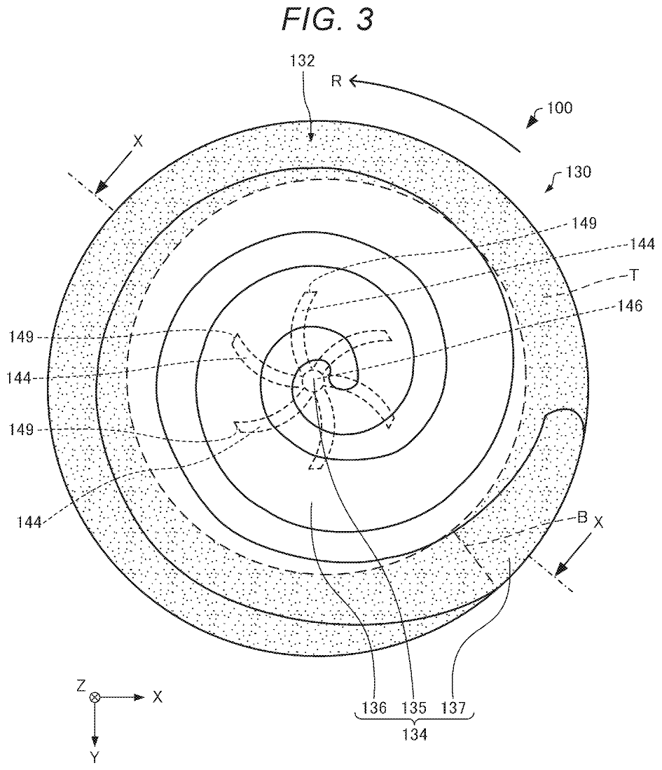

The flat screw 130 has an upper face 131, a grooved face 132 at an opposite side to the upper face 131, and a side face 133 that couples the upper face 131 to the grooved face 132. The grooved face 132 is provided with a first groove 134. Here, FIG. 2 is a perspective view schematically showing the flat screw 130. FIG. 3 is a plan view schematically showing a relative positional relationship between the flat screw 130 and the barrel 140 and is a perspective view seen from the bottom of the barrel 140. Note that FIGS. 2 and 3 show a state in which the up-and-down positional relationship is reversed to that of the state shown in FIG. 1 for the sake of convenience.

As shown in FIGS. 2 and 3, the first groove 134 of the flat screw 130 includes a central portion 135, a coupling portion 136, and a material supply portion 137.

The central portion 135 is a portion opposed to a communication hole 146 provided in the barrel 140. The central portion 135 communicates with the communication hole 146. The shape of the central portion 135 is, for example, a circular shape when viewed from the Z-axis direction.

The coupling portion 136 is a portion that couples the central portion 135 to the material supply portion 137. In the illustrated example, the shape of the coupling portion 136 is a spiral shape swirling around the central portion 135 when viewed from the Z-axis direction. The coupling portion 136 is provided in a spiral shape from the central portion 135 toward the outer circumference of the grooved face 132.

The material supply portion 137 is a portion provided at the outer circumference of the grooved face 132. That is, the material supply portion 137 is a portion provided at the side face 133 of the flat screw 130. The material supply portion 137 is a portion in contact with the outer circumference of the flat screw 130 when viewed from the Z-axis direction. In other words, the material supply portion 137 is a portion where the side face 133 is opened, and is a portion viewable from the lateral side of the flat screw 130. The depth of the material supply portion 137 may be larger than the depth of the coupling portion 136. A material fed from the material feeding section 110 is supplied to the first groove 134 from the material supply portion 137. The supplied material passes through the coupling portion 136 and the central portion 135 and is conveyed to the communication hole 146 provided in the barrel 140.

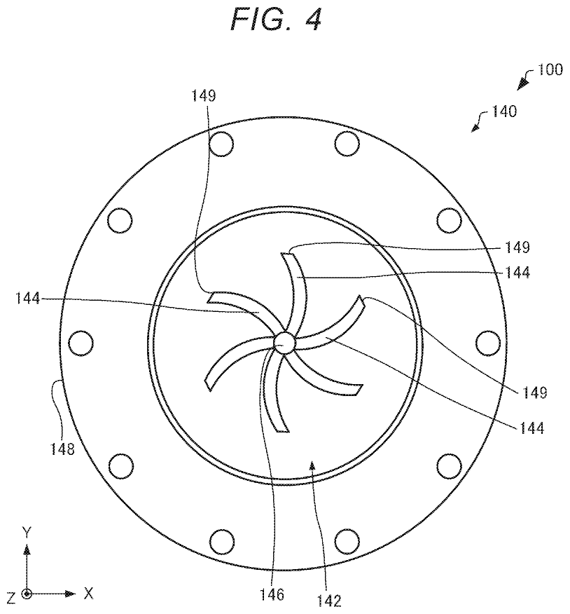

The barrel 140 is provided below the flat screw 130 as shown in FIG. 1. The barrel 140 has an opposed face 142 opposed to the grooved face 132 of the flat screw 130. At the center of the opposed face 142, the communication hole 146 is provided. The communication hole 146 communicates with a nozzle flow channel 172. Here, FIG. 4 is a plan view schematically showing the barrel 140.

In the opposed face 142 of the barrel 140, a second groove 144 and the communication hole 146 are provided as shown in FIG. 4. A plurality of second grooves 144 are provided. In the illustrated example, six second grooves 144 are provided, but the number thereof is not particularly limited. The plurality of second grooves 144 are provided around the communication hole 146 when viewed from the Z-axis direction. The second groove 144 is coupled to the communication hole 146. The second groove 144 is provided from the communication hole 146 toward an outer circumference 148. The second groove 144 has a function of guiding the molten material to the communication hole 146.

As shown in FIG. 3, the shape of the second groove 144 is an arched shape protruding in a rotational direction R of the flat screw 130 when viewed from the Z-axis direction. More specifically, the second groove 144 is a groove in a spiral shape curved along the rotational direction R of the flat screw 130 from an end 149 at the outer circumference 148 side of the second groove 144 toward the communication hole 146. In other words, as illustrated example, the rotational direction R of the flat screw 130 is a counterclockwise direction, and the shape of the second groove 144 is an arched shape extending in a clockwise direction from the communication hole 146. The shape of the second groove 144 is not particularly limited, and may be, for example, a linear shape.

The end 149 at the outer circumference 148 side of the second groove 144 is located inside a track T drawn by a boundary line B between the material supply portion 137 and the coupling portion 136 when the flat screw 130 is rotated once when viewed from the Z-axis direction. That is, the end 149 of the second groove 144 does not overlap with the track T when viewed from the Z-axis direction. In the illustrated example, the outer circumference of the flat screw 130 is a circle, and the boundary line B is orthogonal to the outer circumference of the flat screw 130. Note that in FIG. 3, a multiple dot pattern is imparted to the track T for the sake of convenience.

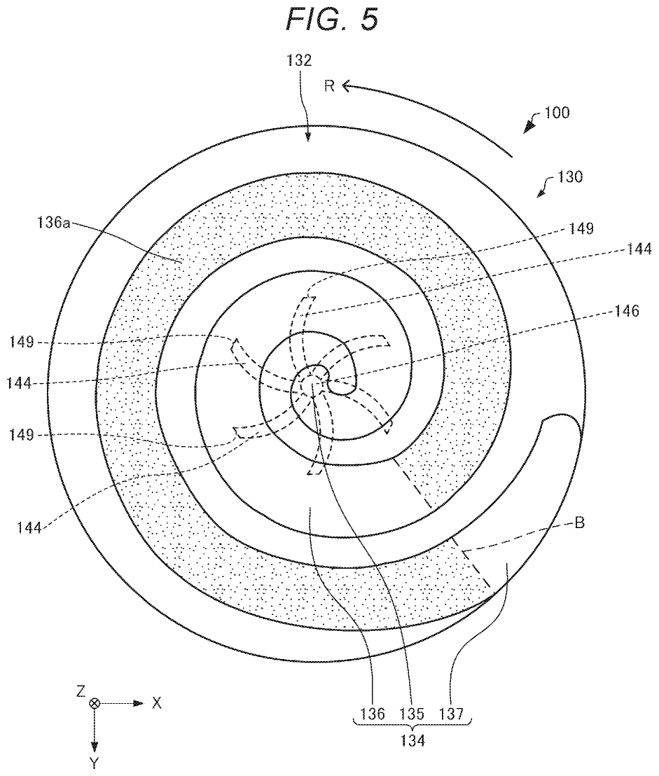

As shown in FIG. 5, the end 149 of the second groove 144 is located closer to the central portion 135 than to an outermost circumferential portion 136a of the coupling portion 136 when viewed from the Z-axis direction. That is, the end 149 of the second groove 144 does not overlap with the outermost circumferential portion 136a when viewed from the Z-axis direction. The outermost circumferential portion 136a is a portion that is not sandwiched in between the coupling portions 136 when viewed from the Z-axis direction. Note that FIG. 5 is a plan view schematically showing a relative positional relationship between the flat screw 130 and the barrel 140 and is a perspective view seen from the bottom of the barrel 140 in the same manner as in FIG. 3. In FIG. 5, a multiple dot pattern is imparted to the outermost circumferential portion 136a.

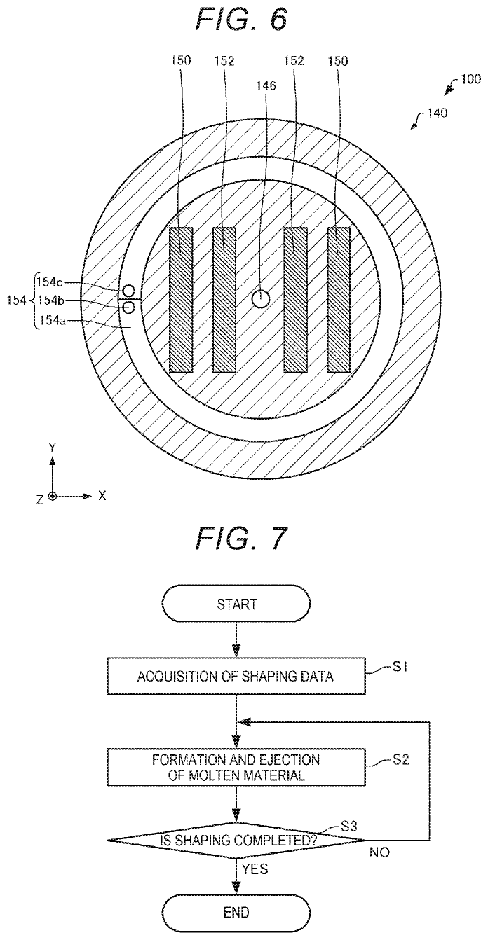

The first heating section 150 and the second heating section 152 are provided inside the barrel 140 as shown in FIG. 1. The heating sections 150 and 152 heat the material supplied to the first groove 134 from the material feeding section 110. The temperature of the first heating section 150 is lower than the temperature of the second heating section 152. The temperature of the first heating section 150 is, for example, lower than the melting point of the material to be supplied. The temperature of the second heating section 152 is, for example, equal to or higher than the melting point of the material to be supplied. Here, FIG. 6 is a cross-sectional view taken along the line VI-VI of FIG. 1 schematically showing the three-dimensional shaping apparatus 100.

The first heating section 150 and the second heating section 152 are each, for example, a bar heater as shown in FIG. 6. The heating sections 150 and 152 each may be a ceramic heater or a heating wire heater. In the illustrated example, two first heating sections 150 and two second heating sections 152 are provided. Between the two first heating sections 150, the communication hole 146 and the two second heating sections 152 are located. Between the two second heating sections 152, the communication hole 146 is located. Although not illustrated, the heating sections 150 and 152 each may be a ring heater having an annular shape.

The number of heating sections included in the three-dimensional shaping apparatus 100 is not particularly limited. For example, the three-dimensional shaping apparatus 100 may include a third heating section in addition to the first heating section 150 and the second heating section 152.

The cooling section 154 is provided inside the barrel 140. The cooling section 154 includes, for example, a cooling flow channel 154a, an inlet 154b, and an outlet 154c. In the illustrated example, the cooling flow channel 154a is provided along the outer circumference of the barrel 140. The cooling flow channel 154a is provided so as to surround the communication hole 146 and the heating sections 150 and 152 when viewed from the Z-axis direction. The cooling section 154 cools the material supplied to the first groove 134 from the material feeding section 110. By the heating sections 150 and 152 and the cooling section 154, a temperature gradient is formed such that the temperature gradually increases from the outside to the inside of the barrel 140.

Into the cooling flow channel 154a, a refrigerant is introduced from the inlet 154b. The refrigerant introduced from the inlet 154b flows through the cooling flow channel 154a and is discharged from the outlet 154c. Although not illustrated, the cooling section 154 includes a refrigerant circulation device coupled to the inlet 154b and the outlet 154c. The refrigerant circulation device circulates the refrigerant from the outlet 154c to the inlet 154b while cooling the refrigerant. Examples of the refrigerant include water and industrial water.

A place where the heating sections 150 and 152 and the cooling section 154 are provided is not particularly limited. The heating sections 150 and 152 and the cooling section 154 may be provided in the screw case 122 or in the flat screw 130.

As shown in FIG. 1, the nozzle 170 is provided below the barrel 140. The nozzle 170 ejects the molten material supplied from the plasticizing section 120 toward the stage 20. In the nozzle 170, the nozzle flow channel 172 and a nozzle hole 174 are provided. The nozzle flow channel 172 communicates with the communication hole 146. The nozzle hole 174 communicates with the nozzle flow channel 172. The nozzle hole 174 is an opening provided in a tip portion of the nozzle 170. The planar shape of the nozzle hole 174 is, for example, a circular shape. The molten material supplied to the nozzle flow channel 172 from the communication hole 146 is ejected from the nozzle hole 174.

### 1.3. Shaping Process

Next, a shaping process of the three-dimensional shaping apparatus 100 according to the present embodiment will be described. FIG. 7 is a flowchart for illustrating the shaping process of the three-dimensional shaping apparatus 100 according to the present embodiment. The control unit 40 starts the shaping process for shaping a three-dimensional shaped article OB when receiving a predetermined start operation. Hereinafter, the shaping process of the control unit 40 will be sequentially described.

### 1.3.1. Step S1

First, the control unit 40 performs a process for acquiring shaping data for shaping the three-dimensional shaped article OB as shown in FIG. 7. The shaping data are data that represent information about the movement path of the nozzle 170 with respect to the shaping face 22 of the stage 20, the amount of the molten material to be ejected from the nozzle 170, the rotation speed of the flat screw 130, the temperatures of the heating sections 150 and 152, the temperature of the cooling section 154, and the like.

The shaping data are generated by, for example, slicer software installed on the computer coupled to the three-dimensional shaping apparatus 100. The slicer software generates the shaping data by, for example, reading shape data representing the shape of the three-dimensional shaped article OB generated using 3D CAD (Computer-Aided Design) software or 3D CG (Computer Graphics) software, and dividing the shape of the three-dimensional shaped article OB into layers having a predetermined thickness. The shape data read by the slicer software are data of an STL (Standard Triangulated Language) format, an IGES (Initial Graphics Exchange Specification) format, an STEP (Standard for the Exchange of Product) format, or the like. The shaping data generated by the slicer software are represented by a G-code, an M-code, or the like. The control unit 40 acquires the shaping data from the computer coupled to the three-dimensional shaping device 100 or a recording medium such as a USB (Universal Serial Bus) memory.

### 1.3.2. Step S2

Subsequently, the control unit 40 performs a process for forming a molten material and ejecting the formed molten material. Specifically, first, the control unit 40 controls the rotation of the flat screw 130, the temperatures of the heating sections 150 and 152, and the temperature of the cooling section 154 based on the acquired shaping data, thereby plasticizing a material and forming a molten material.

By the rotation of the flat screw 130, the material fed from the material feeding section 110 is supplied to the first groove 134 from the material supply portion 137 of the flat screw 130. The material introduced into the first groove 134 is conveyed to the central portion 135 along the path of the first groove 134. While being conveyed through the first groove 134, the material is melted by shearing due to the relative rotation of the flat screw 130 to the barrel 140, and heating by the heating sections 150 and 152, and transformed into a molten material in a paste form having fluidity. The molten material collected at the central portion 135 is pressure-fed to the nozzle 170 from the communication hole 146.

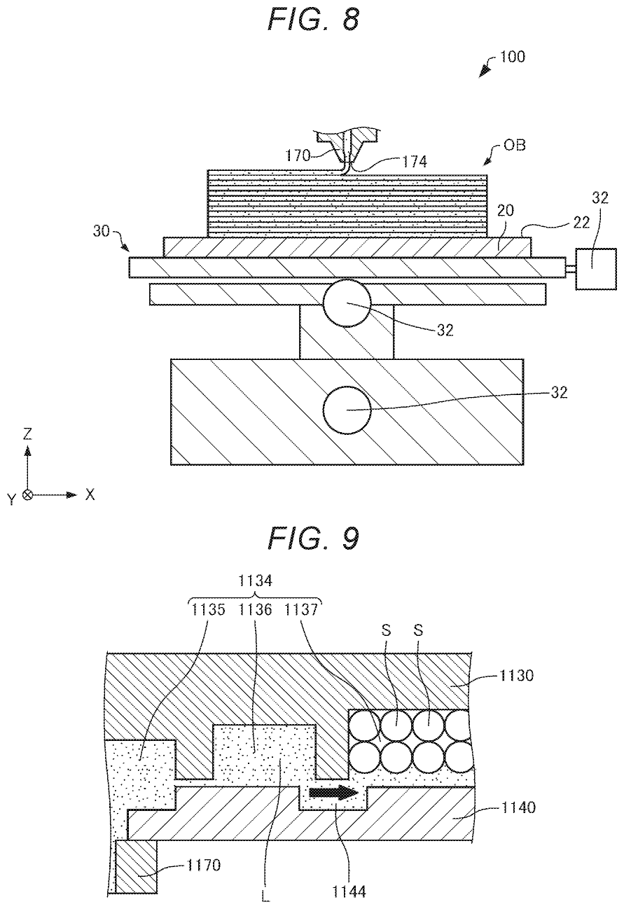

Subsequently, as shown in FIG. 8, the control unit 40 performs a process for ejecting the molten material to the shaping face 22 from the nozzle 170 while changing the relative position of the nozzle 170 to the shaping face 22 by controlling the moving mechanism 30 based on the acquired shaping data. By doing this, for example, a first layer of the three-dimensional shaped article OB is shaped. Note that FIG. 8 is a view for illustrating the shaping process of the three-dimensional shaping apparatus 100, and schematically shows a manner of shaping the three-dimensional shaped article OB by the three-dimensional shaping apparatus 100.

### 1.3.3. Step S3

Subsequently, as shown in FIG. 7, the control unit 40 performs a process for determining whether or not shaping of all the layers of the three-dimensional shaped article OB is completed based on the acquired shaping data. When it is not determined that shaping of all the layers of the three-dimensional shaped article OB is completed (“NO” in Step S3), the control unit 40 returns to Step S2 and shapes, for example, a second layer of the three-dimensional shaped article OB. On the other hand, when it is determined that shaping of all the layers of the three-dimensional shaped article OB is completed (“YES” in Step S3), the control unit 40 finishes the shaping process. The control unit 40 shapes the three-dimensional shaped article OB by repeatedly performing the processes of Step S2 and Step S3 until it is determined that shaping of all the layers of the three-dimensional shaped article OB is completed in Step S3.

### 1.4. Operational Effects

In the plasticizing section 120, the end 149 at the outer circumference 148 side of the second groove 144 is located inside the track T drawn by the boundary line B between the material supply portion 137 of the first groove 134 and the coupling portion 136 when the flat screw 130 is rotated once when viewed from the Z-axis direction. Therefore, in the plasticizing section 120, the material melted in the coupling portion 136 can be prevented from reaching the material supply portion 137 through the second groove 144.

Here, as shown in FIG. 9, when a second groove 1144 overlaps with a material supply portion 1137, the pressure in a coupling portion 1136 is higher than the pressure in the material supply portion 1137, and therefore, a material L melted in the coupling portion 1136 reaches the material supply portion 1137 through the second groove 1144. When the molten material L has reached the material supply portion 1137, a material S in a solid state is melted by the heat of the molten material L. In particular, a portion in contact with a barrel 1140 of the material S in a solid state is easily melted. The coefficient of friction of the molten material L against the barrel 1140 is smaller than that of the material S in a solid state, and is smaller by one digit or more depending on the material. Therefore, when the material is melted, the frictional force of the material against the barrel 1140 becomes smaller than the frictional force of the material against a flat screw 1130. Due to this, the material S in a solid state sticks to the flat screw 1130 and is rotated together with the flat screw 1130 in a skidding manner and is not conveyed to the coupling portion 1136 of a first groove 1134. As a result, the material cannot be stably plasticized.

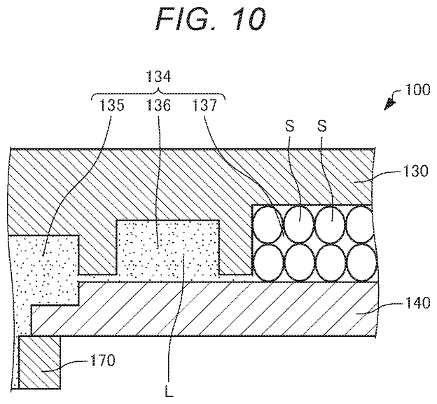

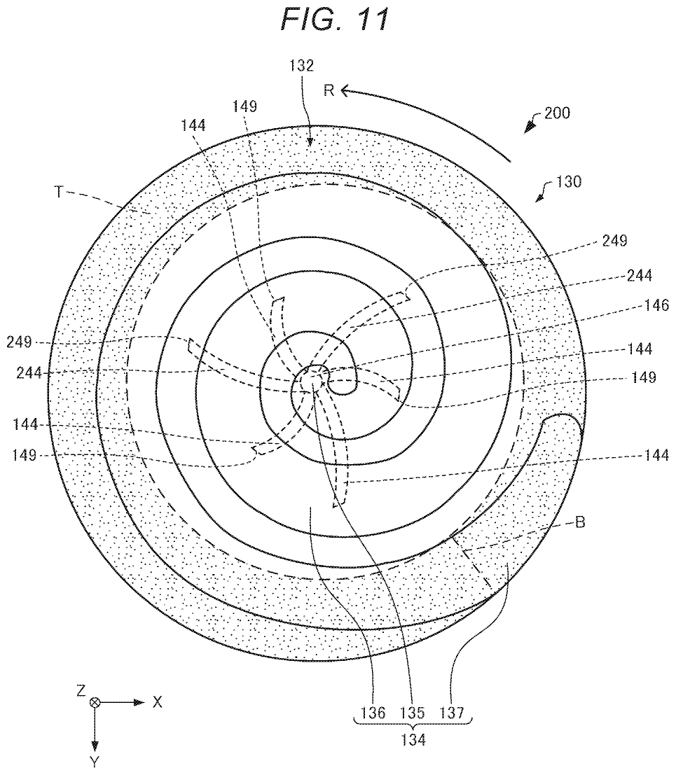

On the other hand, in the plasticizing section 120, the end 149 of the second groove 144 is located inside the track T as described above, and as shown in FIG. 10, the second groove 144 does not overlaps with the material supply portion 137, and therefore, the material L melted in the coupling portion 136 can be prevented from reaching the material supply portion 137 through the second groove 144. Due to this, the material can be kept in a solid state in the material supply portion 137. Accordingly, the frictional force of the material against the barrel 140 can be made larger than the frictional force of the material against the flat screw 130, and the material S in a solid state can be extruded to the coupling portion 136 by rotation of the flat screw 130. As a result, the material can be stably plasticized. For example, a bridge phenomenon in which a new plasticized material is not supplied to the communication hole 146 can be prevented.

Note that FIG. 9 is a cross-sectional view schematically showing an example in which the second groove 1144 overlaps with the material supply portion 1137 of the first groove 1134. The first groove 1134 includes a central portion 1135, the coupling portion 1136, and the material supply portion 1137. FIG. 10 is a cross-sectional view taken along the line X-X of FIG. 3 schematically showing the three-dimensional shaping apparatus 100 according to the present embodiment. Further, in FIGS. 9 and 10, the flat screws 130 and 1130, the barrels 140 and 1140, and the nozzles 170 and 1170 are shown in a simplified manner for the sake of convenience.

In the plasticizing section 120, the shape of the coupling portion 136 is a spiral shape swirling around the central portion 135, and the end 149 at the outer circumference 148 side of the second groove 144 is located closer to the central portion 135 than to the outermost circumferential portion 136a of the coupling portion 136 when viewed from the Z-axis direction. Therefore, in the plasticizing section 120, the molten material can be prevented from reaching the outermost circumferential portion 136a through the second groove 144.

In the plasticizing section 120, the material supply portion 137 is provided at the side face 133 of the flat screw 130. Therefore, in the plasticizing section 120, the material can be supplied from the lateral side of the flat screw 130.

In the plasticizing section 120, the second groove 144 is a groove in a spiral shape along the rotational direction R of the flat screw 130 from the end 149 at the outer circumference 148 side of the second groove 144 toward the communication hole 146. Therefore, in the plasticizing section 120, as compared with a case where the second groove is not a groove in a spiral shape along the rotational direction R from the end at the outer circumference side toward the communication hole, the material melted in the coupling portion 136 can be smoothly conveyed to the central portion 135 by the second groove 144.

### 2. Modifications of Three-Dimensional Shaping Apparatus

### 2.1. First Modification

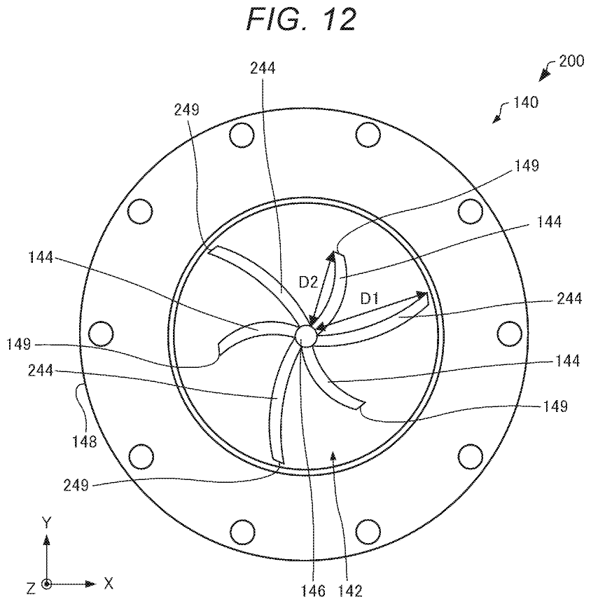

Next, a three-dimensional shaping apparatus according to a first modification of the present embodiment will be described with reference to the drawings. FIG. 11 is a plan view schematically showing a relative positional relationship between the flat screw 130 and the barrel 140 of a three-dimensional shaping apparatus 200 according to a first modification of the present embodiment and is a perspective view seen from the bottom of the barrel 140. FIG. 12 is a plan view schematically showing the barrel 140 of the three-dimensional shaping apparatus 200 according to the first modification of the present embodiment.

Hereinafter, in the three-dimensional shaping apparatus 200 according to the first modification of the present embodiment, members having the same function as the constituent members of the three-dimensional shaping apparatus 100 according to the present embodiment described above are denoted by the same reference numerals, and a detailed description thereof is omitted. The same also applies to three-dimensional shaping apparatuses according to second and third modifications of the present embodiment described below.

As shown in FIGS. 11 and 12, the three-dimensional shaping apparatus 200 is different from the three-dimensional shaping apparatus 100 described above in that the apparatus includes a third groove 244. The third groove 244 is coupled to the communication hole 146. The third groove 244 is provided from the communication hole 146 toward the outer circumference 148. The shape of the third groove 244 is an arched shape protruding in the rotational direction R of the flat screw 130 when viewed from the Z-axis direction. A shortest distance D1 between an end 249 at the outer circumference 148 side of the third groove 244 and the communication hole 146 is larger than a shortest distance D2 between the end 149 at the outer circumference 148 side of the second groove 144 and the communication hole 146 when viewed from the Z-axis direction. That is, the length of the third groove 244 is larger than the length of the second groove 144. The shape of the third groove 244 is not particularly limited, and may be, for example, a linear shape.

In the illustrated example, three second grooves 144 and three third grooves 244 are provided. The three second grooves 144 and the three third grooves 244 are alternately provided along the rotational direction R. Note that the number of second grooves 144 and the number of third grooves 244 are not particularly limited. For example, one second groove 144 may be provided, and five third grooves 244 may be provided, or five second grooves 144 may be provided, and one three third groove 244 may be provided.

In the three-dimensional shaping apparatus 200, as described above, the shortest distance D1 between the end 249 at the outer circumference 148 side of the third groove 244 and the communication hole 146 is larger than the shortest distance D2 between the end 149 at the outer circumference 148 side of the second groove 144 and the communication hole 146 when viewed from the Z-axis direction. Therefore, in the three-dimensional shaping apparatus 200, as compared with a case where the third groove is not provided, the material melted in the coupling portion 136 is easily conveyed to the central portion 135 by the third groove 244. Accordingly, the molten material can be quickly conveyed to the central portion 135, and the material can be efficiently plasticized.

### 2.2. Second Modification

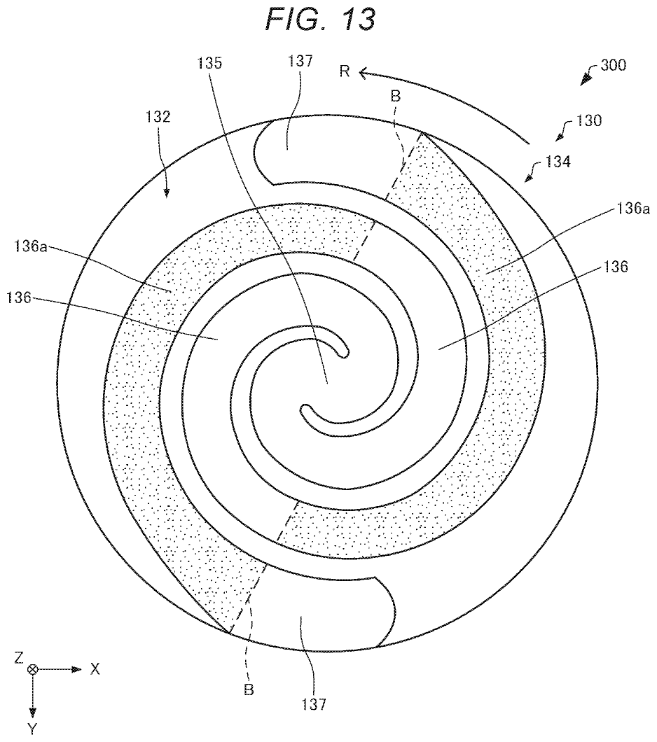

Next, a three-dimensional shaping apparatus according to a second modification of the present embodiment will be described with reference to the drawing. FIG. 13 is a plan view schematically showing the flat screw 130 of a three-dimensional shaping apparatus 300 according to the second modification of the present embodiment.

In the three-dimensional shaping apparatus 100 described above, as shown in FIG. 3, the first groove 134 includes one coupling portion 136 and one material supply portion 137.

On the other hand, in the three-dimensional shaping apparatus 300, as shown in FIG. 13, the first groove 134 includes a plurality of coupling portions 136 and a plurality of material supply portions 137. In the illustrated example, the first groove 134 includes two coupling portions 136 and two material supply portions 137. Note that the number of coupling portions 136 and the number of material supply portions 137 are not particularly limited.

Note that the outermost circumferential portion 136a of the coupling portion 136 is a portion that is not sandwiched in between any coupling portions 136 when a plurality of coupling portions 136 are provided. For example, as shown in FIG. 13, when two coupling portions 136 are provided, the outermost circumferential portion 136a is a portion that is not sandwiched in between one of the coupling portions 136 and the other coupling portion 136. In FIG. 12, a multiple dot pattern is imparted to the outermost circumferential portion 136a.

### 2.3. Third Modification

Next, a three-dimensional shaping apparatus according to a third modification of the present embodiment will be described. In the three-dimensional shaping apparatus 100 described above, as the material for shaping the three-dimensional shaped article, ABS in a pellet form is used.

On the other hand, in the three-dimensional shaping apparatus according to the third modification of the present embodiment, as the material to be used in the plasticizing section 120, for example, a material containing any of various materials such as a material having thermoplasticity other than ABS, a metal material, and a ceramic material as a main material can be exemplified. Here, the “main material” means a material serving as a main component for forming the shape of the three-dimensional shaped article and refers to a material whose content ratio is 50 wt % or more in the three-dimensional shaped article. In the above-mentioned material, a material obtained by melting such a main material singly, and a material formed into a paste by melting some components contained together with the main material are included.

As the material having thermoplasticity, for example, a thermoplastic resin can be used. Examples of the thermoplastic resin include general-purpose engineering plastics such as polypropylene (PP), polyethylene (PE), polyacetal (POM), polyvinyl chloride (PVC), polyamide (PA), acrylonitrile-butadiene-styrene (ABS), polylactic acid (PLA), polyphenylene sulfide (PPS), polycarbonate (PC), modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyether ether ketone (PEEK).

In the material having thermoplasticity, a pigment, a metal, a ceramic, or other than these, an additive such as a wax, a flame retardant, an antioxidant, or a heat stabilizer, or the like may be mixed. The material having thermoplasticity is plasticized and converted into a molten state by rotation of the flat screw 130 and heating by the heating sections 150 and 152 in the plasticizing section 120. The molten material formed in this manner is cured by lowering the temperature after being ejected from the nozzle 170.

The material having thermoplasticity is desirably ejected from the nozzle 170 in a completely molten state by being heated to a temperature equal to or higher than the glass transition temperature thereof. For example, ABS has a glass transition temperature of about 120° C. and the temperature thereof when it is ejected from the nozzle 170 is desirably about 200° C.

In the plasticizing section 120, in place of the above-mentioned material having thermoplasticity, for example, a metal material may be used as the main material. In that case, it is desirable that a component that melts when forming the molten material is mixed in a powder material obtained by pulverizing the metal material into a powder form, and the resulting material is fed to the plasticizing section 120.

Examples of the metal material include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, stainless steel, cobalt-chromium-molybdenum, a titanium alloy, a nickel alloy, an aluminum alloy, a cobalt alloy, and a cobalt-chromium alloy.

In the plasticizing section 120, in place of the above-mentioned metal material, a ceramic material can be used as the main material. Examples of the ceramic material include oxide ceramics such as silicon dioxide, titanium dioxide, aluminum oxide, and zirconium oxide, non-oxide ceramics such as aluminum nitride.

The powder material of the metal material or the ceramic material to be fed to the material feeding section 110 may be a mixed material obtained by mixing multiple types of single metal powders or alloy powders or ceramic material powders. Further, the powder material of the metal material or the ceramic material may be coated with, for example, any of the above-mentioned thermoplastic resins or any other thermoplastic resin. In that case, the material may be configured to exhibit fluidity by melting the thermoplastic resin in the plasticizing section 120.

To the powder material of the metal material or the ceramic material to be fed to the material feeding section 110, for example, a solvent can also be added. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetyl acetone; alcohols such as ethanol, propanol, and butanol; tetra-alkyl ammonium acetates; sulfoxide-based solvents such as dimethyl sulfoxide and diethyl sulfoxide; pyridine-based solvents such as pyridine, y-picoline, and 2,6-lutidine; tetra-alkyl ammonium acetates (for example, tetra-butyl ammonium acetate, etc.); and ionic liquids such as butyl carbitol acetate.

In addition thereto, for example, a binder may also be added to the powder material of the metal material or the ceramic material to be fed to the material feeding section 110. Examples of the binder include an acrylic resin, an epoxy resin, a silicone resin, a cellulosic resin, or another synthetic resin, or PLA (polylactic acid), PA (polyamide), PPS (polyphenylene sulfide), PEEK (polyether ether ketone), and other thermoplastic resins.

### 3. Injection Molding Apparatus

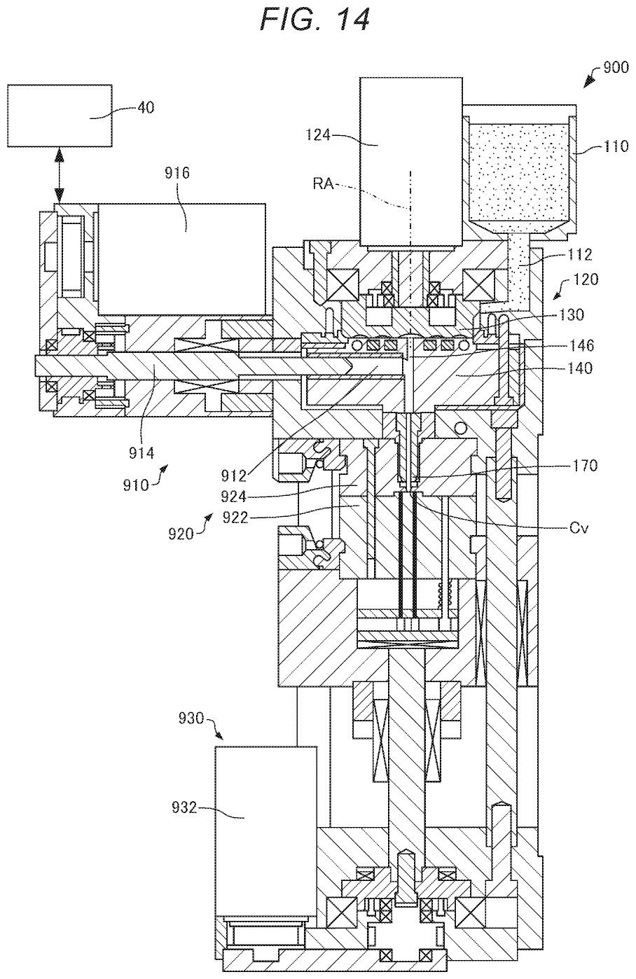

Next, an injection molding apparatus according to the present embodiment will be described with reference to the drawing. FIG. 14 is a cross-sectional view schematically showing an injection molding apparatus 900 according to the present embodiment.

The injection molding apparatus 900 includes, for example, the plasticizing section 120 described above as shown in FIG. 14. The injection molding apparatus 900 further includes, for example, a material feeding section 110, a nozzle 170, an injection mechanism 910, a mold portion 920, a mold clamping device 930, and a control unit 40.

The plasticizing section 120 plasticizes a material supplied to the first groove 134 of the flat screw 130 to form a molten material in a paste form having fluidity, and guides the molten material to the injection mechanism 910 from the communication hole 146.

The injection mechanism 910 includes an injection cylinder 912, a plunger 914, and a plunger driving section 916. The injection mechanism 910 has a function of injecting the molten material in the injection cylinder 912 into a cavity Cv. The control unit 40 controls an injection amount of the molten material from the nozzle 170. The injection cylinder 912 is a member in a substantially cylindrical shape coupled to the communication hole 146 of the barrel 140. The plunger 914 slides inside the injection cylinder 912, and pressure-feeds the molten material in the injection cylinder 912 to the nozzle 170 coupled to the plasticizing section 120. The plunger 914 is driven by the plunger driving section 916 constituted by a motor.

The mold portion 920 includes a movable mold 922 and a fixed mold 924. The movable mold 922 and the fixed mold 924 are provided opposed to each other. Between the movable mold 922 and the fixed mold 924, the cavity Cv that is a space corresponding to the shape of a molded article is provided. The molten material is pressure-fed to the cavity Cv by the injection mechanism 910. The nozzle 170 ejects the molten material to the mold portion 920.

The mold clamping device 930 includes a mold driving section 932. The mold driving section 932 has a function of opening and closing the movable mold 922 and the fixed mold 924. The mold clamping device 930 drives the mold driving section 932 so as to move the movable mold 922 to open and close the mold portion 920.

The above-mentioned embodiments and modifications are examples, and the present disclosure is not limited thereto. For example, it is also possible to appropriately combine the respective embodiments and the respective modifications.

The present disclosure includes substantially the same configuration, for example, a configuration having the same function, method, and result, or a configuration having the same object and effect as the configuration described in the embodiments. Further, the present disclosure includes a configuration in which a part that is not essential in the configuration described in the embodiments is substituted. Further, the present disclosure includes a configuration having the same operational effect as the configuration described in the embodiments, or a configuration capable of achieving the same object as the configuration described in the embodiments. In addition, the present disclosure includes a configuration in which a known technique is added to the configuration described in the embodiments.

From the above-mentioned embodiments, the following contents are derived.

One aspect of a plasticizing device is a plasticizing device that plasticizes a material, and includes

a screw that is rotated around a rotational axis and that has a grooved face provided with a first groove,
a barrel that has an opposed face opposed to the grooved face and that is provided with a communication hole communicating with the first groove at the opposed face, and
a heating section that heats the material supplied to the first groove, wherein
the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

According to the plasticizing device, the material melted in the coupling portion can be prevented from reaching the material supply portion through the second groove. Therefore, the material can be kept in a solid state in the material supply portion. Accordingly, the frictional force of the material against the barrel can be made larger than the frictional force of the material against the flat screw, and the material in a solid state can be extruded to the coupling portion by rotation of the flat screw. As a result, the material can be stably plasticized.

In one aspect of the plasticizing device,

a third groove that is coupled to the communication hole and that extends from the communication hole toward the outer circumference of the opposed face may be provided at the opposed face, and
when viewed from the rotational axis direction, a shortest distance between an end at the outer circumferential side of the third groove and the communication hole may be larger than a shortest distance between the end at the outer circumferential side of the second groove and the communication hole.

According to the plasticizing device, as compared with a case where the third groove is not provided, the material melted in the coupling portion is easily conveyed to the central portion by the third groove. Accordingly, the molten material can be quickly conveyed to the central portion, and the material can be efficiently plasticized.

In one aspect of the plasticizing device,

when viewed from the rotational axis direction, a shape of the coupling portion may be a spiral shape swirling around the central portion, and
when viewed from the rotational axis direction, the end at the outer circumferential side of the second groove may be located closer to the central portion than to an outermost circumferential portion of the coupling portion.

According to the plasticizing device, the molten material can be prevented from reaching the outermost circumferential portion through the second groove.

In one aspect of the plasticizing device, when viewed from the rotational axis direction, the outermost circumferential portion may be a portion that is not sandwiched in between by the coupling portions.

In one aspect of the plasticizing device, the material supply portion may be provided at a side face of the screw.

According to the plasticizing device, the material can be supplied from the lateral side of the flat screw.

In one aspect of the plasticizing device, when viewed from the rotational axis direction, the second groove may be a groove in a spiral shape along a rotational direction of the screw from the end at the outer circumferential side of the second groove toward the communication hole.

According to the plasticizing device, as compared with a case where the shape of the second groove is not an arched shape protruding in the rotational direction, the material melted in the coupling portion can be smoothly conveyed to the central portion by the second groove.

One aspect of a three-dimensional shaping apparatus is a three-dimensional shaping apparatus that shapes a three-dimensional shaped article, and includes

a plasticizing section that plasticizes a material to form a molten material, and
a nozzle that ejects the molten material supplied from the plasticizing section to a stage, wherein
the plasticizing section includes

a screw that is rotated around a rotational axis and that has a grooved face provided with a first groove,

a barrel that has an opposed face opposed to the grooved face and that is provided with a communication hole communicating with the first groove at the opposed face, and

a heating section that heats the material supplied to the first groove,

the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

According to the three-dimensional shaping apparatus, the material can be stably plasticized.

One aspect of an injection molding apparatus includes

a plasticizing section that plasticizes a material to form a molten material, and
a nozzle that injects the molten material supplied from the plasticizing section to a mold, wherein
the plasticizing section includes

a screw that is rotated around a rotational axis and that has a grooved face provided with a first groove,

a barrel that has an opposed face opposed to the grooved face and that is provided with a communication hole communicating with the first groove at the opposed face, and

a heating section that heats the material supplied to the first groove,

the first groove includes

a central portion opposed to the communication hole,

a material supply portion that is provided at an outer circumference of the grooved face and that is supplied with the material, and

a coupling portion that couples the central portion to the material supply portion,

a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

According to the injection molding apparatus, the material can be stably plasticized.

What is claimed is:

1. A plasticizing device that plasticizes a material, comprising:
a screw that is rotated around a rotational axis and that has a grooved face provided with a first groove;
a barrel that has an opposed face opposed to the grooved face and that is provided with a communication hole communicating with the first groove at the opposed face; and
a heating section that heats the material supplied to
the first groove, wherein the first groove includes
a central portion opposed to the communication hole,
a material supply portion that is provided at an outer circumference of the grooved face and that is supplied with the material, and
a coupling portion that couples the central portion to the material supply portion,
a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

2. The plasticizing device according to claim 1, wherein
a third groove that is coupled to the communication hole and that extends from the communication hole toward the outer circumference of the opposed face is provided at the opposed face, and
when viewed from the rotational axis direction, a shortest distance between an end at the outer circumferential side of the third groove and the communication hole is larger than a shortest distance between the end at the outer circumferential side of the second groove and the communication hole.

3. The plasticizing device according to claim 1, wherein
when viewed from the rotational axis direction, a shape of the coupling portion is a spiral shape swirling around the central portion, and
when viewed from the rotational axis direction, the end at the outer circumferential side of the second groove is located closer to the central portion than to an outermost circumferential portion of the coupling portion.

4. The plasticizing device according to claim 3, wherein when viewed from the rotational axis direction, the outermost circumferential portion is a portion that is not sandwiched in between the coupling portions.

5. The plasticizing device according to claim 1, wherein the material supply portion is provided at a side face of the screw.

6. The plasticizing device according to claim 1, wherein when viewed from the rotational axis direction, the second groove is a groove in a spiral shape along a rotational direction of the screw from the end at the outer circumferential side of the second groove toward the communication hole.

7. A three-dimensional shaping apparatus that shapes a three-dimensional shaped article, comprising:
a plasticizing section that plasticizes a material to form a molten material; and
a nozzle that ejects the molten material supplied from the plasticizing section to a stage, wherein
the plasticizing section includes
a screw that is rotated around a rotational axis and that has a grooved face provided with a first groove,
a barrel that has an opposed face opposed to the grooved face and that is provided with a communication hole communicating with the first groove at the opposed face, and
a heating section that heats the material supplied to the first groove,
the first groove includes
a central portion opposed to the communication hole,
a material supply portion that is provided at an outer circumference of the grooved face and that is supplied with the material, and
a coupling portion that couples the central portion to the material supply portion,
a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.

8. An injection molding apparatus, comprising:
a plasticizing section that plasticizes a material to form a molten material; and
a nozzle that injects the molten material supplied from the plasticizing section to a mold, wherein
the plasticizing section includes
a screw that is rotated around a rotational axis and that has a grooved face provided with a first groove,
a barrel that has an opposed face opposed to the grooved face and that is provided with a communication hole communicating with the first groove at the opposed face, and
a heating section that heats the material supplied to the first groove,
the first groove includes
a central portion opposed to the communication hole,
a material supply portion that is provided at an outer circumference of the grooved face and that is supplied with the material, and
a coupling portion that couples the central portion to the material supply portion,
a second groove that is coupled to the communication hole and that extends from the communication hole toward an outer circumference of the opposed face is provided at the opposed face, and
when viewed from the rotational axis direction, an end at the outer circumferential side of the second groove is located inside a track drawn by a boundary line between the material supply portion and the coupling portion when the screw is rotated once.
